(19) United States
(12) Patent Application Publication
(10) Pub. No.: US 2024/0420283 A1
(43) Pub. Date: Dec. 19, 2024

(54) DEVICE-ADAPTIVE SUPER-RESOLUTION BASED APPROACH TO ADAPTIVE STREAMING

(71) Applicant: BITMOVIN, INC., San Francisco, CA (US)

(72) Inventors: Minh NGUYEN, San Francisco, CA (US); Ekrem CETINKAYA, San Francisco, CA (US); Christian TIMMERER, 41 Drumm Street, CA (US); Hermann HELLWAGNER, San Francisco, CA (US)

(73) Assignee: BITMOVIN, INC., San Francisco, CA (US)

(21) Appl. No.: 18/701,693

(22) PCT Filed: Oct. 19, 2021
(86) PCT No.: PCT/US2021/055580

§ 371 Date: Apr. 16, 2024

(51) Int. Cl. G06T 3/4053; G06T 7/00

(52) U.S. Cl. CPC G06T 3/4053; G06T 7/0002; G06T 2207/30168

(57) ABSTRACT

A mobile device capable of device-adaptive super-resolution based adaptive streaming may include a super-resolution-based adaptive bitrate (SR-based ABR) application configured to receive an input and determine a quality of a representation of a video to request based on the input, the SR-based ABR application being able to compute a cost of requesting the quality of representation based on a cost function. The mobile device may apply an SR network to the representation of the video to upscale the representation of the video to a desired resolution. The mobile device also may include a display configured to play back a segment of the video. A method for SR-based adaptive streaming may include receiving an input, determining whether to request a lower resolution representation of a video segment based on the input, and applying an SR network to the lower resolution representation to upscale it to a desired resolution.

### BACKGROUND OF INVENTION

Mobile video streaming data has been growing significantly in recent years. In response to the high demand for efficient video streaming services in heterogeneous environments, video segments in HTTP Adaptive Streaming (HAS) are provided as a set of bitrate-resolution pairs that is also referred to as bitrate ladder. However, HAS incurs variations of video quality in streaming sessions because of throughput fluctuation.

In HAS, the video at the server is encoded with multiple versions to adapt to heterogeneous devices. Each version is then split into temporal segments with the same duration. An adaptive bitrate (ABR) algorithm at the client is responsible for choosing the quality of the segments to be downloaded with the objective of providing high video quality and decreasing stall possibility. Despite its popularity, HAS still suffers from quality variation because of the severe cellular throughput oscillation. Traditional ABR algorithms select the quality of segments based on some client-side information such as instant buffer occupancy, and/or network parameters, e.g., throughput. Those algorithms can be classified into (i) throughput-based, (ii) buffer-based, and (iii) hybrid adaptation. While throughput-based and buffer-based algorithms merely rely on the information of network condition and buffer occupancy, respectively, hybrid schemes take into account both throughput and buffer level to choose segments' qualities. These conventional techniques aim to select high bitrate segments (i.e., highest available or possible given the throughput and/or buffer) for better video quality. However, this strategy requires tremendous data delivered over the network, which costs a lot of bandwidth and leads to network congestion.

Super-resolution (SR) techniques have been developed to recover high-resolution images from corresponding lower resolution images. Despite the increasing computational power of mobile devices in recent years, there are limitations to be considered when applying the refinement methods such as SR for video streaming in the mobile domain-power consumption and execution time being the two main challenges. Previous attempts to apply SR neural networks in mobile devices (e.g., using per-video deep neural network (DNN) to enhance the downloaded low-quality segments) still require high computational power that is not compatible with most mobile devices.

Providing optimal Quality of Experience (QoE) is still challenging. Thus, it is desirable to have a device-adaptive SR based approach to adaptive streaming for mobile devices.

### BRIEF SUMMARY

The present disclosure provides techniques for device-adaptive super-resolution based approach to adaptive streaming. A mobile device capable of device-adaptive super-resolution based adaptive streaming may include: a super-resolution-based adaptive bitrate (SR-based ABR) application configured to receive an input and to determine a quality of a representation of a video to request based on the input, the SR-based ABR application configured to implement an SR-based ABR algorithm configured to compute a cost of requesting the quality of representation based on a cost function; a processor configured to execute instructions stored in a memory to apply an SR network to the representation of the video, the SR network configured to upscale the representation of the video to a desired resolution; and a display configured to play back a segment of the video. In some examples, the input comprises one, or a combination, of a bandwidth availability, a buffer status, and a battery level. In some examples, the SR-based ABR application is configured to consider only the representations whose bitrates are less than the last estimated throughput with a margin μ. In some examples, the SR-based ABR application is configured to consider all representations regardless of whether a representation's bitrate is less than, the same, or more than the last estimated throughput. In some examples, the SR-based ABR application is configured to select an optimal representation to request for each segment of the video based on a trade-off among a plurality of factors. In some examples, the factors include one, or a combination, of a segment quality, bandwidth availability, data usage, and power consumption. In some examples, the SR-based ABR application is configured to determine an SR cost and a non-SR cost using an SR cost function and a non-SR cost function, respectively, the SR cost representing a cost of using an SR network to upscale each representation of a given segment of the video, the non-SR cost representing the cost of providing each representation for playback without upscaling by an SR network. In some examples, the SR-cost function comprises a weighted function of a bandwidth cost, a buffer cost, an SR-enhanced quality cost, and a power cost. In some examples, the non-SR cost function comprises a weighted function of a bandwidth cost, a buffer cost, and a quality cost. In some examples, the SR network comprises two or more convolution layers, at least one convolution layer comprising a sub-pixel convolution layer. In some examples, the SR network further comprises two or more rectified linear activation units.

A method for device-adaptive super-resolution based adaptive streaming may include: receiving an input comprising one, or a combination of, a bandwidth input, a buffer status input, and a battery level input; determining whether to request a lower resolution or higher resolution representation of a first video segment from a server; requesting the lower resolution representation from the server in response to a determination to request the lower resolution representation; receiving the lower resolution representation of the first video segment; and applying an SR network to the lower resolution representation of the first video segment, the SR network configured to upscale the lower resolution representation to a desired resolution. In some examples, the determining whether to request the lower resolution representation comprises computing an SR cost and a non-SR cost using an SR cost function and a non-SR cost function, respectively. In some examples, the SR cost function comprises a weighted function of a bandwidth cost, a buffer cost, an SR-enhanced quality cost, and a power cost. In some examples, the non-SR cost function comprises a weighted function of a bandwidth cost, a buffer cost, and a quality cost. In some examples, the method also includes normalizing the SR cost and the non-SR cost. In some examples, the determination to request the lower resolution representation is based on a determination of the SR cost being lower than the non-SR cost for the first video segment. In some examples, the desired resolution is 2×, 3×, or 4× the lower resolution. In some examples, the method also includes playing an upscaled version of the first video segment at the desired resolution. In some examples, the method also includes: determining whether to request a lower resolution or higher resolution representation of a second video segment from a server; requesting the higher resolution representation from the server in response to a determination to request the higher resolution representation; receiving the higher resolution representation of the second video segment, wherein the higher resolution is the same as, close to, or better than, the desired resolution. In some examples, the determination to request the higher resolution representation is based on a determination of the non-SR cost being lower than the SR cost for the second video segment.

### BRIEF DESCRIPTION OF THE DRAWINGS

Various non-limiting and non-exhaustive aspects and features of the present disclosure are described hereinbelow with references to the drawings, wherein:

FIG. 1A is a simplified block diagram showing a system for implementing a device-adaptive SR based approach to adaptive streaming for mobile devices, in accordance with one or more embodiments.

FIG. 1B is a simplified block diagram of an exemplary SR-based ABR network, in accordance with one or more embodiments.

FIG. 2A is a simplified block diagram of an exemplary computing system configured to perform steps of the method illustrated in FIGS. 3 and 4A-4B, in accordance with one or more embodiments.

FIG. 2B is a simplified block diagram of an exemplary distributed computing system implemented by a plurality of the computing devices, in accordance with one or more embodiments.

FIG. 3 is flow diagram illustrating an exemplary method for a device-adaptive SR based approach to adaptive streaming for mobile devices, in accordance with one or more embodiments.

FIGS. 4A-4B are flow diagrams illustrating exemplary methods for initiating a mobile device for implementing a device-adaptive SR based approach to adaptive streaming, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

The invention is directed to a device-adaptive super-resolution (SR) based approach to adaptive streaming for mobile devices. This invention employs SR techniques in order to address video quality fluctuation and improve the QoE in mobile streaming applications (e.g., HTTP adaptive streaming (HAS)). The invention applies an SR network on the client side to improve visual quality while reducing bandwidth usage.

Super-resolution (SR) can be defined as the task of increasing the spatial resolution of an input image. Interpolation-based SR methods such as bilinear or bicubic interpolation may be used, as well as learning-based SR methods (e.g., convolutional/deep neural networks (DNNs)). This invention leverages the SR technique to enhance the video quality under the throughput fluctuation while minimizing the data usage of mobile devices, including a selection of an appropriate SR network for a mobile environment and employing a weighted sum model (i.e., ABR algorithm) to select an optimal representation for each segment of a video based on a plurality of factors related to QoE, device characteristics, and user preference, including (a) segment quality, (b) buffer occupancy (e.g., whether a streaming application is experiencing rebuffering or other streaming delays), (c) data usage, (d) bandwidth availability (e.g., current measured bandwidth, estimated bandwidth), and (e) power consumption.

Different SR networks with different upscaling factors and computational complexities (e.g., efficient sub-pixel convolutional neural network (ESPCN), fast super-resolution convolution neural network (FSRCNN), an SR based ABR network, a modified version of these networks, and other networks) may be stored for selection. Device characteristics relevant to SR network selection may include screen resolution, CPU/GPU chip identification, device power (e.g., fully charged, charging, low battery), local device storage.

To implement a device-adaptive SR based approach to adaptive streaming, one or more SR networks may be stored in the client device before starting playback of a video. When the client device launches an SR based adaptive streaming application for the first time, characteristics of the device may be sent to an SR storage server, and a suitable set of SR networks are sent to the client device and stored by the client device storage. The set of SR networks may be updated, periodically or ad hoc (e.g., pushed from the server, or downloaded by the application, with or separately from other updates to the application), for example, when performance gained from the online training by the server exceeds a pre-defined performance threshold.

In the server, different SR networks may be trained to improve the quality of SR images for different upscaling factors. Online training for stored SR networks may be performed to further improve performance and may be provided to clients once improvements are sufficient to exceed a pre-defined performance threshold. Performance thresholds may be based on processing time and amount of quality improvement, among other performance factors.

A lightweight SR network may be configured to downscale an input image by a factor of two or more to operate in a lower resolution space. The SR network may be configured to output the input image in the desired higher resolution, for example, at least one sub-pixel convolution (i.e., pixel shuffle) layer may be used, including one at the end of the network to match the output image to the target resolution. In some examples, another sub-pixel convolution layer may be included in the middle of the network to upscale the feature maps to the input resolution. In some examples, the lightweight SR network may comprise double the number of convolution layers compared to ESPCN while reducing the kernel size, such that the number of network parameters is reduced while increasing generalization of the network due to an increased number of intermediate features.

Two or more residual connections may be added to the lightweight SR network to allow the flow of information between initial layers. A first residual connection may be added after a first convolution layer so that the input information can be reused after the first upscaling. Other residual connections may be added before the last convolution layer to reuse the output obtained from a low-resolution processing part of the network.

An ABR algorithm that leverages SR techniques (i.e., SR-based ABR algorithm) with the aim of upgrading user's QoE while saving data usage may be configured to select the representation (i.e., corresponding to a bitrate and quality) with the lowest cost based on a weighted sum model. The lowest cost may be based on a comparison of a non-SR cost and an SR cost. The non-SR cost may comprise a weighted function of bandwidth_cost, buffer_cost, and quality_cost, representing the cost of providing the highest appropriate quality representation to a mobile device for playback without upscaling by an SR network. The non-SR cost may be represented by the following equation:

$${C}^{c} ( i ) = ∝ \times {C}_{t} ( i ) + β \times {C}_{b} ( i ) + γ \times {C}_{q}^{c} ( i )$$

where Cₜ(i) represents a throughput cost (i.e., bandwidth_cost) with a given weight parameter ∝, C_{b}(i) represents a buffer cost (i.e., buffer_cost) with a given weight parameter β, and C_{q}^{c}(i) represents a conventional quality cost without SR-based upscaling (i.e., quality_cost) with a given weight parameter γ. Downloading a representation i consumes an amount of data corresponding to its bitrate rᵢ. A higher bitrate leads to more data usage and lower bitrate to less data usage, so throughput cost Cₜ(i) may be computed as a function of bitrate rᵢ and an estimated throughput (e.g., the smaller of a smooth throughput calculation and a last measured throughput). A margin parameter ω may be applied to represent different types of broadband connections (e.g., WiFi, 3G, 4G, 5G, etc.). Buffer cost C_{b}(i) may be computed as a function of download time and buffer occupancy (e.g., a measure of current buffer minus a low buffer threshold).

The SR cost may comprise a weighted function of bandwidth_cost, buffer_cost, SR-enhanced quality_cost, and power_cost, and may be represented by the following equation:

$${C}^{s , x} ( i ) = ∝ \times {C}_{t} ( i ) + β \times {C}_{b} ( i ) + γ \times {C}_{q}^{s , x} ( i ) + δ \times {C}_{p} ( i )$$

where C_{q}^{s,x}(i) represents an SR-enhanced quality cost (i.e., quality_cost) with an upscale factor x and Cₚ(i) represents a power cost (i.e., power_cost), as applying an SR network will consume battery power. Power_cost Cₚ(i) may take into account energy consumed when the SR network is used, and may be computed as power consumption of a quality version of representation i over power consumption of a lowest quality of representation i, which will consume the highest power.

∝, β, γ, δ represent the weight parameters, which may differ for different device types (e.g., weight parameter may be greater than 0 for a mobile device, higher or lower depending on characteristics of the mobile device, and equal to 0 or omitted for a non-mobile device) and end user's preference (e.g., weight parameter may by greater than 0 if the user considers the corresponding cost, higher (or lower) if the user wants to increase (or decrease) the corresponding cost, and equal to 0 or omitted if the cost is not considered). Said weight parameters also may differ between the SR cost and the non-SR cost. In an example, a weight parameter may be a value between 0 and 1 and may add up to 1. In other examples, a weight parameter may be a higher or lower value and may add up to a different value.

The lower of the non-SR cost and SR cost may be selected as the represented cost C(i) for the representation i. For example, C(i)=min{C^{c}(i), C^{s,x}(i)}. If the non-SR cost and SR cost are in different ranges, a normalization step may be applied to normalize the costs on a common scale (e.g., 0 to 1, 0 to 5, 1 to 10, −1 to +1). An SR-based ABR application may be configured to consider only the representations whose bitrates are less than the last estimated throughput with a margin μ (e.g., μ=0.1 or other value in a range from 0 to 1). In other examples, an SR-based ABR application may be configured to consider all representations regardless of whether a representation's bitrate is less than, the same, or more than the last estimated throughput.

In an example, for a low bitrate representation (e.g., 240p, 540p, etc.), there may be a low bandwidth_cost and low buffer_cost (i.e., shorter download time), but an SR network that can perform a higher degree of upscaling (e.g., 3× to 4× to achieve 1080p, 4 k, etc.) may be selected, which likely requires a high power_cost. In another example, for a high bitrate representation (e.g., 1080p, 4 k, 8 k, etc.), there may be a high bandwidth_cost and high buffer_cost, but may not require any power_cost for applying an SR network for upscaling. An SR-based ABR application, as described herein, may be configured to select an optimal representation for each segment based on the trade-off among these and other factors related to QoE, user preferences, and device characteristics.

In some examples, SR networks that perform well for different resolutions may be stored in an SR based adaptive streaming application (e.g., by embedding them in the streaming application data), and a set of SR networks appropriate for the client device characteristics may be downloaded the first time a client device launches said streaming application. Such SR networks may be trained until their upscaling performance with respect to given device characteristics meets a pre-defined performance threshold. Existing and new SR networks may be trained further on a server to improve their performance to meet and exceed such pre-defined performance thresholds, and to expand the set of SR networks appropriate for the client device characteristics. In other examples, one or more SR networks may be trained on a given video (e.g., overfit to the video) and stored on a server to be provided along with a first time request of the given video (e.g., a low resolution representation that may then be upscaled by the one or more SR networks) when requested for streaming.

### Examples Systems

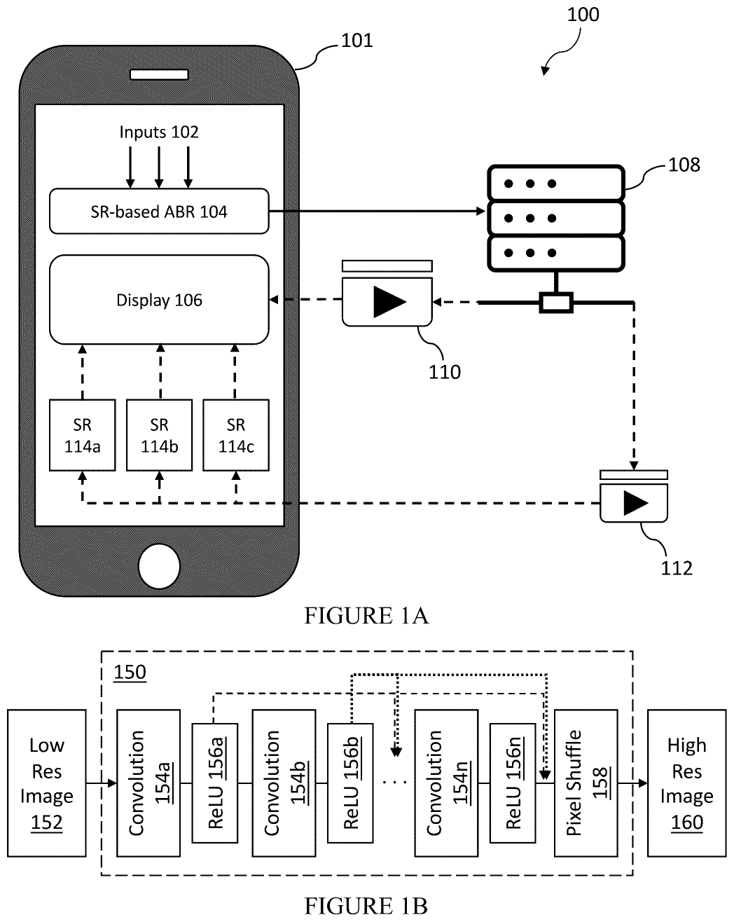

FIG. 1A is a simplified block diagram showing a system for implementing a device-adaptive SR based approach to adaptive streaming for mobile devices, in accordance with one or more embodiments. System 100 includes mobile device 101 and server 108. Mobile device 101 may include SR-based ABR 104, an application configured to receive inputs 102 and to determine a quality (i.e., high bitrate, medium bitrate, low bitrate) of representation of a video to request based on inputs 102 using the SR-based ABR algorithms and cost functions described herein. Inputs 102 may include bandwidth availability (e.g., current measured bandwidth, estimated bandwidth), buffer status (e.g., buffer usage amount, buffer availability amount, actual or estimated), battery level or other indication of available device power, among other inputs. Mobile device 101 also may include display 106 and may be configured to store SR networks 114a-114c, which may provide varying degrees of upscaling (e.g., SR 114a may be configured to upscale video by 2× resolution, SR 114b may be configured to upscale video by 3× resolution, and SR 114c may be configured to upscale video by 4× resolution). In some examples, SR networks 114a-114c may be downloaded initially with the first launch of the SR-based ABR 104 to provide a respective measure of upscaling for device characteristics of mobile device 101. In other examples, each of SR networks 114a-114c may be provided with a requested video representation of a given resolution (e.g., video 112) to provide the necessary upscaling for playback using display 106 at an optimal resolution.

In an example, where display 106 is capable of playback at 1080p resolution, SR-based ABR 104 may determine, based on inputs 102, that the non-SR cost (e.g., C^{c}(i) or a weighted function of bandwidth_cost, buffer_cost, and quality_cost, as described herein) to request a 1080p representation of a given video is higher than the SR cost (e.g., C^{s,x}(i) or a weighted function of bandwidth_cost, buffer_cost, SR-enhanced quality_cost, and power_cost, as described herein) to request a 540p representation of a given video along with the application of an SR network (e.g., one of SR networks 114a-114c) to achieve a 1080p resolution to play on display 106. For example, bandwidth and/or buffer availability may be low, while power may be sufficient or more than sufficient to run one or more of SR networks 114a-114c. In this example, SR-based ABR 104 may request a 540p representation of the video from server 108, and device 101 may receive a 540p video (e.g., segment) representation 112 to be upscaled (i.e., 2×) by one of SR networks 114a-c to achieve a 1080p version of the video to play back on display 106. In another example, representation 112 may be 240p and one of SR networks 114a-c may be configured to upscale representation 112 4× to achieve 1080p. In some examples, SR networks 114a-c may comprise a set of SR networks trained by server 108 to be capable of upscaling any video by a desired magnitude resolution (e.g., 2×, 3×, 4×, or more) with device characteristics of mobile device 101 with a performance that meets and/or exceeds a pre-defined performance threshold. SR networks 114a-c may be downloaded from server 108 with an initial launch of SR-based ABR 104, and updated periodically or ad hoc with new or better-trained SR networks when available from server 108. In other examples, one or more of SR networks 114a-c may be trained (e.g., overfitted) on video representation 112, and stored, by server 108, to be provided to mobile device 101 along with an initial download of video representation 112.

In another example, with the same display 106 capable of playback at 1080p resolution, SR-based ABR 104 may determine, based on inputs 102, that the non-SR cost to request a 1080p representation of a given video is lower than the SR cost to request a 540p representation of a given video. For example, bandwidth and/or buffer availability may be medium or high (e.g., sufficiently high to download a 1080p version of the video without rebuffering and with a relatively short download time), and power may not be high or may be lower than would be required to run one of SR networks 104a-c. In this example, SR-based ABR 104 may request a 1080p representation of the video from server 108, and device 101 may receive a 1080p video (e.g., segment) representation 110 to be played on display 106 (i.e., without application of an SR network).

FIG. 1B is a simplified block diagram of an exemplary SR-based ABR network, in accordance with one or more embodiments. Network 150 includes convolution layers 154a-n, rectified linear activation units (i.e., activation functions) (ReLUs) 156a-n, and pixel shuffle (i.e., sub-pixel convolutional layer) 158. In an example, a low resolution image 152 may be input to network 150 (e.g., at a first convolution layer 154a), which is configured to output high resolution image 160. In some examples, one or more of convolution layers 154a-n may be configured differently from others (e.g., number of output features, kernel size). In some examples, a maximum value may be set for one or more of the latter ReLUs 156a-n. In some examples, residual connections may be included to reuse output from earlier (i.e., lower resolution) layers. For example, the dashed arrow shows an output from ReLU 156a being provided as input to convolution 154n and pixel shuffle 158, and the dotted arrow shows an output from ReLU 156b being provided as input to convolution 154n and pixel shuffle 158.

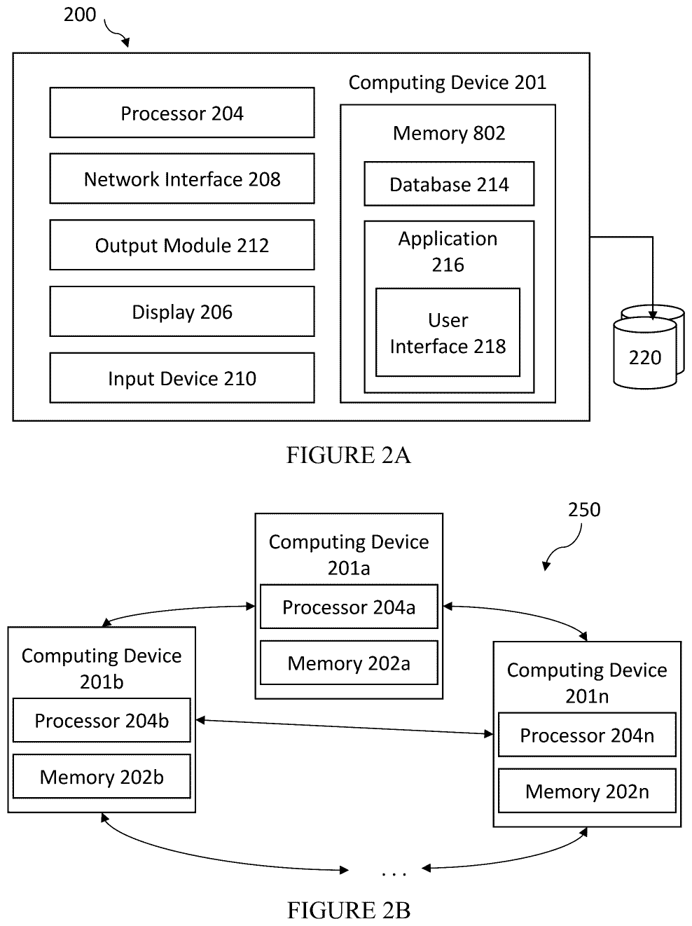

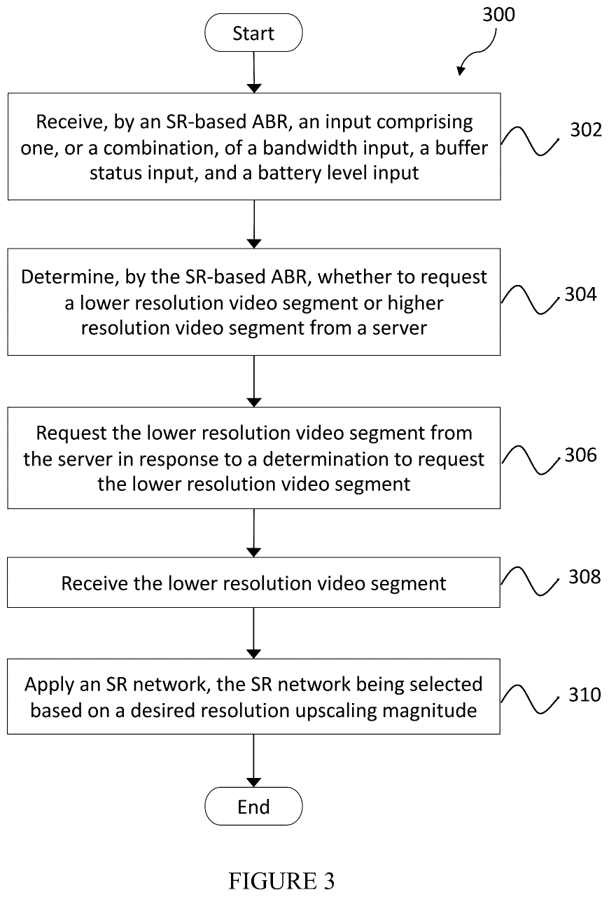

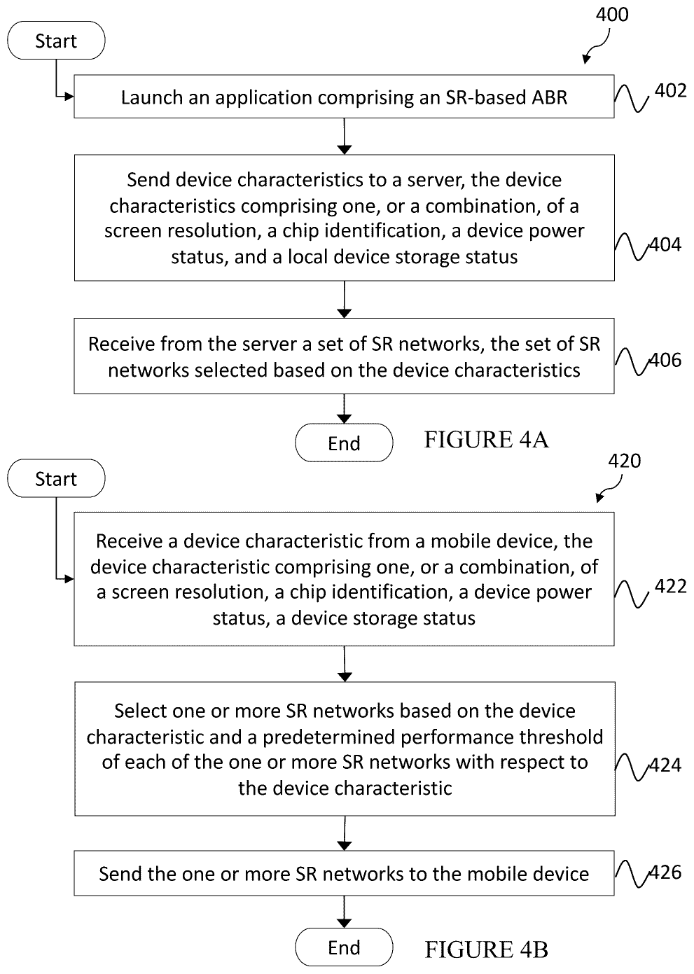

FIG. 2A is a simplified block diagram of an exemplary computing system configured to perform steps of the method illustrated in FIGS. 3 and 4A-4B, in accordance with one or more embodiments. In one embodiment, computing system 200 may include computing device 201 and storage system 220. Storage system 220 may comprise a plurality of repositories and/or other forms of data storage, and it also may be in communication with computing device 201. In another embodiment, storage system 220, which may comprise a plurality of repositories, may be housed in one or more of computing device 201. In some examples, storage system 220 may store SR networks, video data, bitrate ladders, instructions, programs, and other various types of information as described herein. This information may be retrieved or otherwise accessed by one or more computing devices, such as computing device 201, in order to perform some or all of the features described herein. Storage system 220 may comprise any type of computer storage, such as a hard drive, memory card, ROM, RAM, DVD, CD-ROM, write-capable, and read-only memories. In addition, storage system 220 may include a distributed storage system where data is stored on a plurality of different storage devices, which may be physically located at the same or different geographic locations (e.g., in a distributed computing system such as system 250 in FIG. 2B). Storage system 220 may be networked to computing device 201 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 201, which in some examples may be included in mobile device 201 and in other examples may be included in server 108, also may include a memory 202. Memory 202 may comprise a storage system configured to store a database 214 and an application 216. Application 216 (e.g., similar to SR-based ABR 104) may include instructions which, when executed by a processor 204, cause computing device 201 to perform various steps and/or functions (e.g., implementing an SR-based ABR algorithm), as described herein. Application 216 further includes instructions for generating a user interface 218 (e.g., graphical user interface (GUI)). Database 214 may store various algorithms (e.g., SR-based ABR algorithms) and/or data, including neural networks (e.g., convolutional neural networks trained to perform SR techniques) and data regarding bitrates, videos, device characteristics, SR network performance, among other types of data. Memory 202 may include any non-transitory computer-readable storage medium for storing data and/or software that is executable by processor 204, and/or any other medium which may be used to store information that may be accessed by processor 204 to control the operation of computing device 201.

Computing device 201 may further include a display 206 (e.g., similar to display 106), a network interface 208, an input device 210, and/or an output module 212. Display 206 may be any display device by means of which computing device 201 may output and/or display data. Network interface 208 may be configured to connect to a network using any of the wired and wireless short range communication protocols described above, as well as a cellular data network, a satellite network, free space optical network and/or the Internet. Input device 210 may be a mouse, keyboard, touch screen, voice interface, and/or any or other hand-held controller or device or interface by means of which a user may interact with computing device 201. Output module 212 may be a bus, port, and/or other interfaces by means of which computing device 201 may connect to and/or output data to other devices and/or peripherals.

In one embodiment, computing device 201 is a data center or other control facility (e.g., configured to run a distributed computing system as described herein), and may communicate with a media playback device (e.g., mobile device 101). As described herein, system 200, and particularly computing device 201, may be used for video playback, running an SR-based ABR application, upscaling video using an SR network, providing feedback to a server, and otherwise implementing steps in a device-adaptive SR-based approach to adaptive streaming, as described herein. Various configurations of system 200 are envisioned, and various steps and/or functions of the processes described below may be shared among the various devices of system 200 or may be assigned to specific devices.

FIG. 2B is a simplified block diagram of an exemplary distributed computing system implemented by a plurality of the computing devices, in accordance with one or more embodiments. System 250 may comprise two or more computing devices 201a-n. In some examples, each of 201a-n may comprise one or more of processors 204a-n, respectively, and one or more of memory 202a-n, respectively. Processors 204a-n may function similarly to processor 204 in FIG. 2A, as described above. Memory 202a-n may function similarly to memory 202 in FIG. 2A, as described above.

### Example Methods

FIG. 3 is flow diagram illustrating an exemplary method for a device-adaptive SR based approach to adaptive streaming for mobile devices, in accordance with one or more embodiments. Method 300 may begin with receiving, by an SR-based ABR, an input comprising one, or a combination, of a bandwidth input, a buffer status input, and a battery level input, at step 302. In some examples, the SR-based ABR may be implemented by a mobile device. The SR-based ABR may determine whether to request a lower resolution video segment or a higher resolution video segment from a server at step 304, for example, by performing an SR-based ABR algorithm, as described herein, including computing a non-SR cost and an SR cost, and using the lower of the non-SR cost and the SR cost to determine whether to request a lower resolution representation (e.g., if the SR cost is lower) or a higher resolution representation (e.g., if the non-SR cost is lower). In some examples, the SR cost and non-SR cost for each representation may be determined (e.g., calculated, computed, estimated). In an example, the SR cost of a lower resolution representation may be compared directly with the non-SR cost of a higher resolution representation. In another example, a represented cost for each representation (i.e., corresponding to a given resolution) may be determined, as described above, and then the lowest represented cost of two or more representations may be used to determine which representation (i.e., which resolution) video segment to request.

The lower resolution video segment may be requested from the server by the SR-based ABR at step 306, in response to a determination to request the lower resolution video segment, for example, when the represented cost for the lower resolution is lower. The lower resolution video segment may be received by the mobile device at step 308. An SR network may be applied to the lower resolution video segment at step 310, the SR network being selected based on a desired resolution upscaling magnitude to achieve a desired resolution. In some examples, the SR network is one of a set of SR networks downloaded by the mobile device during an initial launch of the SR-based ABR. In other examples, the SR network is one of a set of SR networks downloaded by the mobile device during an update to the SR-based ABR, as may be initiated by a user or pushed by a server. In still other examples, the SR network was trained by a server to overfit for the video segment and is provided to the mobile device with the download of an initial segment of the video being streamed.

In some examples, the SR cost or represented cost of a lower resolution video segment may be lower than the non-SR cost or represented cost of a higher resolution video segment for a first segment, or plurality of segments, of a requested video, and vice versa for a second segment, or plurality of segments, of the requested video, thereby resulting in a lower resolution representation being requested for the first segment, or plurality of segments, and a higher resolution representation being requested for the second segment, or plurality of segments. In some examples, the higher resolution representation is the same as, close to, or better than a desired resolution.

FIGS. 4A-4B are flow diagrams illustrating exemplary methods for initiating a mobile device for implementing a device-adaptive SR based approach to adaptive streaming, in accordance with one or more embodiments. Method 400 may begin with launching an application comprising an SR-based ABR at step 402. Device characteristics (e.g., for the device running the SR-based ABR) may be sent to the server at step 404, the device characteristics comprising one, or a combination, of a screen resolution, a chip identification, a device power status, and a local device storage status. The device may receive from the server a set of SR networks at step 406, the set of SR networks selected based on the device characteristics. In some examples, each of the set of SR networks may further be selected based on its performance with the device characteristics meeting and/or exceeding a pre-defined performance threshold for upscaling videos by a desired magnitude.

Method 420 may begin with receiving a device characteristic from a mobile device (e.g., by a server) at step 422, the device characteristic comprising one, or a combination, of a screen resolution, a chip identification, a device power status, a device storage status, the device power status indicating a power status of the mobile device (e.g., a battery charge level, battery charging, low battery, full battery), the device storage status indicating a storage status of the mobile device (e.g., a storage capacity, storage availability, storage usage). One or more SR networks may be selected at step 424 based on the device characteristic and a predetermined performance threshold of each of the one or more SR networks with respect to the device characteristic. The one or more SR networks (e.g., a selected set) may be sent to the mobile device, in step 426, and may be stored by the mobile device for use in upscaling video segments sent to, or downloaded by, the mobile device, as described herein. In other examples, the one or more SR networks may be sent to the mobile device with an initial video download (e.g., a segment or set of segments), the one or more SR networks being trained on a representation of said video and configured to upscale the video to a desired resolution for playback and viewing using the mobile device.

While specific examples have been provided above, it is understood that the present invention can be applied with a wide variety of inputs, thresholds, ranges, and other factors, depending on the application. For example, the time frames, rates, ratios, and ranges provided above are illustrative, but one of ordinary skill in the art would understand that these time frames and ranges may be varied or even be dynamic and variable, depending on the implementation.

As those skilled in the art will understand a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

1. A mobile device capable of device-adaptive super-resolution based adaptive streaming comprising:
a super-resolution-based adaptive bitrate (SR-based ABR) application configured to receive an input and to determine a quality of a representation of a video to request based on the input, the SR-based ABR application configured to implement an SR-based ABR algorithm configured to compute a cost of requesting the quality of representation based on a cost function;
a processor configured to execute instructions stored in a memory to apply an SR network to the representation of the video, the SR network configured to upscale the representation of the video to a desired resolution; and
a display configured to play back a segment of the video.

2. The device of claim 1, wherein the input comprises one, or a combination, of a bandwidth availability, a buffer status, and a battery level.

3. The device of claim 1, wherein the SR-based ABR application is configured to consider only the representations whose bitrates are less than the last estimated throughput with a margin μ.

4. The device of claim 1, wherein the SR-based ABR application is configured to consider all representations regardless of whether a representation's bitrate is less than, the same, or more than the last estimated throughput.

5. The device of claim 1, wherein the SR-based ABR application is configured to select an optimal representation to request for each segment of the video based on a trade-off among a plurality of factors.

6. The device of claim 5, wherein the factors include one, or a combination, of a segment quality, buffer occupancy, bandwidth availability, data usage, and power consumption.

7. The device of claim 1, wherein the SR-based ABR application is configured to determine an SR cost and a non-SR cost using an SR cost function and a non-SR cost function, respectively, the SR cost representing a cost of using an SR network to upscale each representation of a given segment of the video, the non-SR cost representing the cost of providing each quality representation for playback without upscaling by an SR network.

8. The device of claim 7, wherein the SR-cost function comprises a weighted function of a bandwidth cost, a buffer cost, an SR-enhanced quality cost, and a power cost.

9. The device of claim 7, wherein the non-SR cost function comprises a weighted function of a bandwidth cost, a buffer cost, and a quality cost.

10. The device of claim 1, wherein the SR network comprises two or more convolution layers, at least one convolution layer comprising a sub-pixel convolution layer.

11. The device of claim 10, wherein the SR network further comprises two or more rectified linear activation units.

12. A method for device-adaptive super-resolution based adaptive streaming comprising:
receiving an input comprising one, or a combination of, a bandwidth input, a buffer status input, and a battery level input;
determining whether to request a lower resolution or higher resolution representation of a first video segment from a server;
requesting the lower resolution representation from the server in response to a determination to request the lower resolution representation;
receiving the lower resolution representation of the first video segment; and
applying an SR network to the lower resolution representation of the first video segment, the SR network configured to upscale the lower resolution representation to a desired resolution.

13. The method of claim 12, wherein the determining whether to request the lower resolution representation comprises computing an SR cost and a non-SR cost using an SR cost function and a non-SR cost function, respectively.

14. The method of claim 13, wherein the SR cost function comprises a weighted function of a bandwidth cost, a buffer cost, an SR-enhanced quality cost, and a power cost.

15. The method of claim 13, wherein the non-SR cost function comprises a weighted function of a bandwidth cost, a buffer cost, and a quality cost.

16. The method of claim 13, further comprising normalizing the SR cost and the non-SR cost.

17. The method of claim 13, wherein the determination to request the lower resolution representation is based on a determination of the SR cost being lower than the non-SR cost for the first video segment.

18. The method of claim 12, wherein the desired resolution is 2×, 3×, or 4× the lower resolution.

19. The method of claim 12, further comprising playing an upscaled version of the first video segment at the desired resolution.

20. The method of claim 12, further comprising:
determining whether to request a lower resolution or higher resolution representation of a second video segment from a server;
requesting the higher resolution representation from the server in response to a determination to request the higher resolution representation;
receiving the higher resolution representation of the second video segment, wherein the higher resolution is the same as, close to, or better than, the desired resolution.

21. The method of claim 20, wherein the determination to request the higher resolution representation is based on a determination of the non-SR cost being lower than the SR cost for the second video segment.
